(19) United States
(12) Patent Application Publication
(10) Pub. No.: US 2016/0347481 A1
(43) Pub. Date: Dec. 1, 2016

(54) Energy Absorbing Restraint Device

(71) Applicant: Raytheon Company, Waltham, MA (US)

(72) Inventors: Reza Keshtkar, Tucson, AZ (US); Kevin T. Bredehoft, Tucson, AZ (US)

(73) Assignee: Raytheon Company

(21) Appl. No.: 14/555,472

(22) Filed: Nov. 26, 2014

(51) Int. Cl. B64G 1/64; F42B 15/36; F16B 7/04; F16F 7/12

(52) U.S. Cl. CPC B64G 1/645; F16F 7/12; F42B 15/36; F16B 7/0426

(57) ABSTRACT

An energy absorbing restraint device for a clamp system is disclosed. The clamp system can include a releasable clamp having first and second ends, a securing mechanism connecting the ends and facilitating clamping and release of the clamp, and a restraint device for containing the clamp after release. An energy absorbing member supported about the restraint device can be configured to interface with the releasable clamp to dissipate the impact energy of the releasable clamp and decrease the magnitude of impact shock about the restraint device as created by the release of the clamp.

### GOVERNMENT LICENSE RIGHTS

This invention was made with government support under Contract No. HQ0276-10-C-0005 awarded by the Department of Defense. The government has certain rights in the invention.

### BACKGROUND

Releasable clamps, such as v-band or marman clamps, are widely used in missile and space vehicle applications. For example, a releasable clamp can secure a rocket motor to an upper stage assembly to provide a separation mechanism during flight. In these and similar applications, a restraint device can be employed which limits the travel of the releasable clamp after clamp release. Restraint devices are used to contain a clamp in its released state by restraining the clamp about one of the bodies it was initially secured to before release, allowing the bodies to separate without interference from the clamp.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a perspective view of an example clamp system in accordance with an embodiment of the present invention.

FIG. 2A is a front view of another example clamp system, in a closed position, with an energy absorbing restraint device in accordance with an embodiment of the present invention.

FIG. 2B is a front view of the clamp system of FIG. 2A in an open position.

FIG. 2C is a detailed view of the clamp system of FIG. 2A.

FIG. 2D is a detailed view of the clamp system of FIG. 2B.

FIG. 3A is a side view of an example energy absorbing restraint bracket in accordance with an embodiment of the present invention.

FIG. 3B is a bottom view of the energy absorbing restraint bracket of FIG. 3A.

FIG. 3C is an isometric view of the energy absorbing restraint bracket of FIG. 3A.

FIG. 4A is an example illustration of the clamp system and energy absorbing restraint bracket of FIG. 2A as applied to two separable components of a missile.

FIG. 4B is a detailed view of the clamp system of FIG. 4A.

FIG. 5 is an example illustration of a clamp system in accordance with yet another embodiment of the present invention.

FIG. 6 is an example illustration of an energy absorbing restraint bracket in accordance with another embodiment of the present invention.

FIG. 7 is a flowchart of a method for facilitating absorption of an impact energy of a releasable clamp.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” can be either abutting or connected. Such elements can also be near or close to each other without necessarily contacting each other. The exact degree of proximity can in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although restraint devices for releasable clamps have many advantages, deployment of releasable clamps can be associated with the release of stored strain energy that can generate shock levels (e.g., self-induced high frequency shock levels) upon contact with a restraint device. Such release of energy and subsequent shock levels can be harmful to the one or more bodies secured by the releasable clamp. For example, high frequency shock levels can be harmful to sensitive electronics onboard a portion of a missile or space flight vehicle secured by a releasable clamp operable with a restraint device. Thus, the effectiveness and number of potential applications for clamp systems with restraint devices can increase by mitigating the harmful effects of stored strain energy and high-frequency shock associated with clamp release, such as by reducing or attenuating the shock levels.

Accordingly, a clamp system is disclosed that utilizes an energy absorbing restraint device to attenuate the induced shock levels caused by deployment of a releasable clamp that comes into contact, or that impacts, one or more restraint devices. in some embodiments, the clamp system can include a releasable clamp with first and second ends with a securing mechanism connecting the first and second ends and facilitating clamping and clamp release. One or more restraint devices can be included to limit the displacement of the releasable clamp upon release. An energy absorbing member can be supported about the restraint device, and operable to interface with the releasable clamp to dissipate, at least to some degree, the energy of the releasable clamp upon its release.

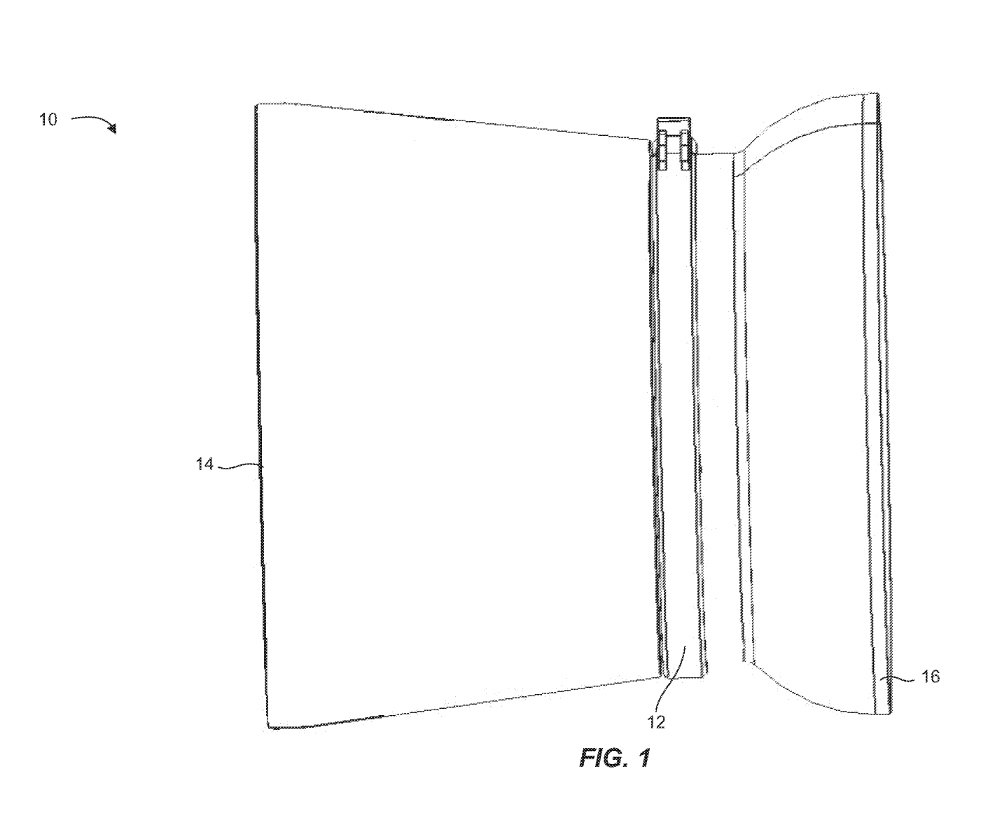

One exemplary embodiment of a clamp system 10 is illustrated in FIG. 1. In this embodiment, the clamp system 10 can comprise a releasable clamp 12 operable for releasably securing a first body 14 and a second body 16. The first and second bodies 14, 16 cancan be adjacent or abutting one another. First and second bodies 14,16 can be configured to interface with one another, as well as to be separable from one another upon release of the releasable clamp 12. The releasable clamp 12 can be operable to apply a clamping force about at least one of the first and second bodies 14,16. For example, releasable clamp 12 can comprise a v-band type clamp, such as a marman clamp or band, which cancan provide coupling between two adjoining interfaces on adjacent bodies. Tensile hoop loads associated with a closed position and applied to the releasable clamp 12, such as a marman band, secure the adjoining interfaces. Achieving an open position releases loads upon the adjoining interfaces of the adjacent bodies and allows for separation of the bodies.

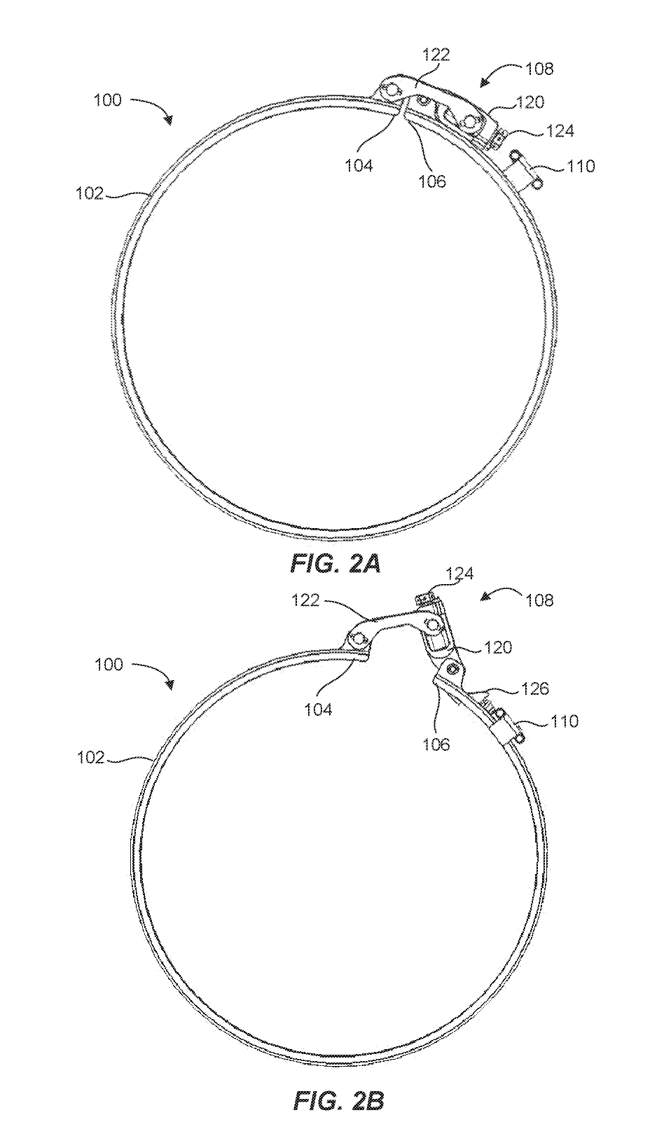

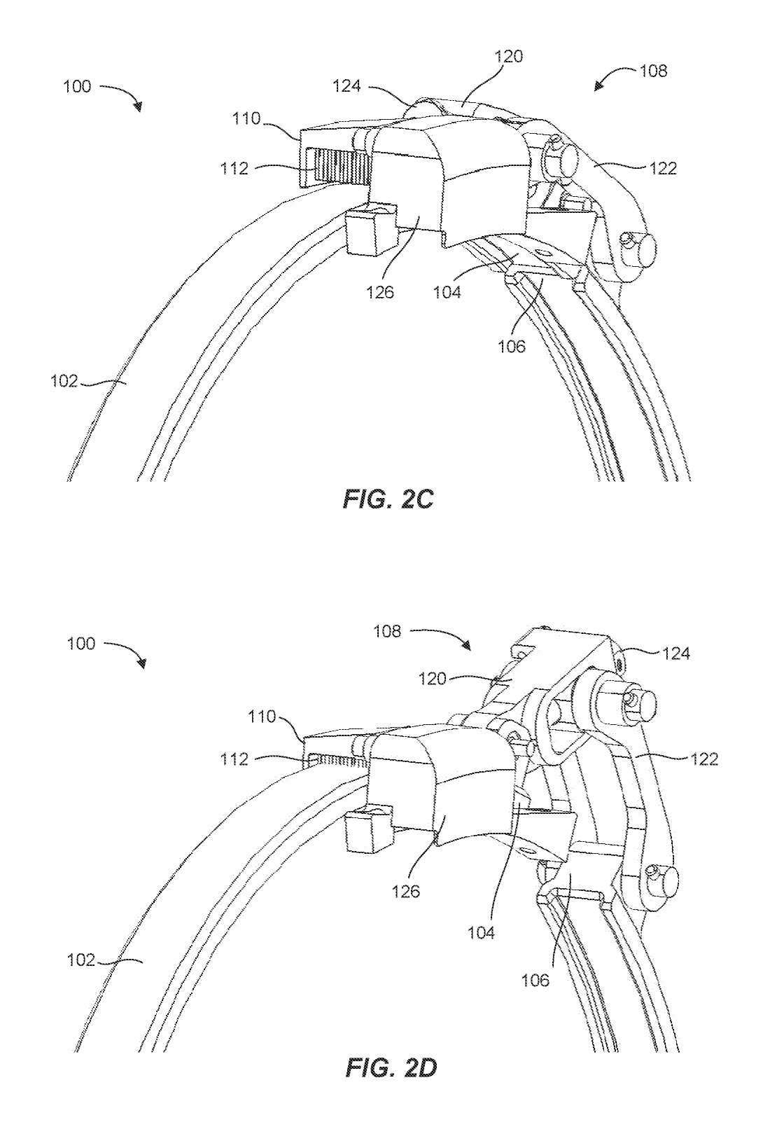

Shown in FIGS. 2A-2D is another example clamp system 100. The clamp system 100 can comprise a releasable clamp 102 having a first end 104 and a second end 106. The releasable clamp 102 can be operable to apply a clamping force to or about one or more bodies. A securing mechanism 108 can be connected to the first and second ends 104, 106 of the releasable clamp 102. The securing mechanism 108 can be operable to facilitate clamping and release of the releasable clamp 102.

In one example of the clamp system 100, the securing mechanism 108 can comprise a lever 120 attached to the first end 104 of the releasable clamp 102. The securing mechanism can further comprise a link 122 attached to the second end 106 of the releasable clamp 102 and also attached to the lever 120. A bolt 124 can be operable to adjust the position of the link 122 relative to the lever 124, which adjustment affects the loads induced by the releasable clamp 102 in a closed or clamped position. In another example, such as a v-band or marman band clamp, a securing mechanism can simply comprise a bolt and nut attached to the first and second ends of the releasable clamp. In these example, tensile hoop loads are created when the releasable clamp is tightened and clamped by bringing the first and second ends of the releasable clamp together. In some embodiments, the securing mechanism 108 can further comprise a pyrotechnic actuator 126 configured to trigger the release of the securing mechanism 108 and facilitate the subsequent release of the releasable clamp 102. Other types of securing mechanisms and release or triggering systems or devices are contemplated, and will be apparent to those skilled in the art.

The clamp system 100 can further comprise one or more restraint devices 110. The restraint device 110 can be configured and operable to limit the displacement of the releasable clamp 102 upon its release or, more specifically, upon release of the securing mechanism 108 and displacement of the releasable clamp 102. An energy absorbing member 112 can be supported about the restraint device 110. The energy absorbing member 112 can be supported about the restraint device 110, and can be operable to interface with the releasable clamp 102 for the purpose of dissipating an impact energy of the releasable clamp 102 upon release of the securing mechanism 108 causing displacement of the releasable clamp 102 and contact with the restraint device 110.

In one example, the energy absorbing member 112 can be supported about the restraint device 110 using an adhesive. Depending upon the particular makeup and configuration of the energy absorbing member 112, the energy absorbing member 112 can be supported about the restraint device 110 in other ways, such as using fasteners.

n one aspect, the energy absorbing member 112 can dissipate the impact energy of the releasable clamp 102 through plastic deformation of the energy absorbing member 112, such as by utilizing a material capable of crushing on impact. Upon release of the securing mechanism 108, the strain energy stored in the releasable clamp 102 converts to kinetic energy, causing the releasable clamp 102 to displace into restraint bracket 110 and energy absorbing member 112. The energy dissipating capabilities of the energy absorbing member 112 can reduce the momentum of the releasable clamp 102 by converting the kinetic energy into heat, thus reducing the velocity of the of the releasable clamp 102 upon impact. Plastic deformation of the energy absorbing member 112 can dissipate the impact energy and velocity of the releasable clamp 102 through conversion to heat. The irreversible or largely irreversible deformation caused by plastic deformation can also significantly decrease the subsequent rebound velocity of the releasable clamp 102 as the plastic deformation will cause the energy absorbing member 112 to maintain its deformed shape with very little expansion or return to its original shape. The reduction in rebound velocity and energy of the releasable clamp 102 leads to less shock and allows the releasable clamp 102 to come to rest in a shorter time period. There are a variety of materials available that can exhibit plastic or substantially plastic deformation properties and that can crush or substantially crush upon impact, such as metals, composites, and plastics. It will be recognized by those skilled in the art that different materials may exhibit different deformation properties, with some exhibiting different crush characteristics than some others. In addition, it is contemplated that composite type materials may be used that contain properties that can dissipate energy as desired herein, without exhibiting significant rebound properties. Indeed, materials that provide suitable dampening and crush characteristics, yet still provide minimal yet acceptable rebound properties are also contemplated for use, and such materials do not necessarily have to be completely or totally plastically deformable. Moreover, the dampening value of the energy absorbing member 112 can vary as needed, such as depending upon the particular application, type of clamp, determined release forces associated with the clamp, acceptable impact parameters, etc.

The restraint device 110 and energy absorbing member 112 can be located at a location where the release energy of the releasable clamp 102 about the restraint device 110 is the greatest. The release energy can be described as the kinetic energy of the releasable clamp 102 after release of the securing mechanism 108, which is converted from the strain energy stored in the releasable clamp 102 in a closed position. In one aspect, the energy absorbing member 112 can be located substantially adjacent the securing mechanism 108. However, those skilled in the art will recognize that the energy absorbing member 112 can be located at any point about the releasable clamp 102 where at least some energy dissipation is desired.

The energy absorbing member 112 can be specifically designed to absorb the impact energy of any given releasable clamp 102. For example, energy absorbing member 112 can comprise a plastically deformable material, such as a metal, a plastic, a composite, or any other plastically deformable material or combination thereof. The energy absorbing member can have a size and shape consistent with the releasable clamp, as well as the required energy dissipation, which can include a desired crush pattern or dampening ability.

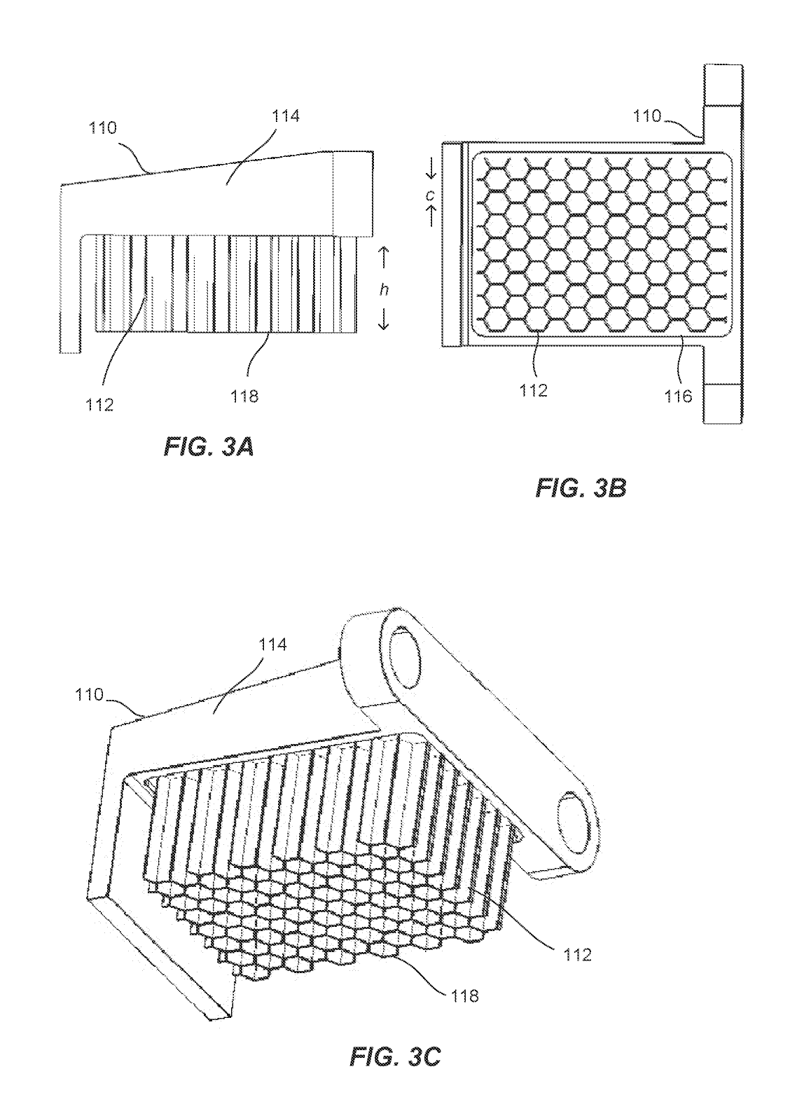

FIGS. 3A-3C show the example restraint device 110 and energy absorbing member 112 of FIGS. 2A-2D. Restraint device 110 can comprise a support base or body 114 and a receiving surface 116. The energy absorbing member 112 can be supported about the restraint device 110, such as by an adhesive. In one example, the energy absorbing member 112 can be supported about the receiving surface 116. The receiving surface 116 can further comprise a recess in which adhesive can be applied and the energy absorbing member 112 can be inserted (see FIG. 3C). This configuration is not intended to be limiting in any way as those skilled in the art will recognize that the energy absorbing member 112 can be supported about the restraint device 110 in a variety of manners, including being formed integrally with the restraint device 110.

The energy absorbing member 112 can be operable to undergo plastic deformation in response to a load. For example, the energy absorbing member 112 can comprise any material suitable for dissipating the release energy of the releasable clamp 102 through the release of heat in plastic deformation. In an embodiment of the invention, the material of the energy absorbing member 112 can provide a progressive crush pattern for optimum dissipation of energy. A progressive crush pattern can be one in which a linear relationship exists between the force applied to the material and the displacement or crushing of the material. An energy absorbing member 112 providing a progressive crush pattern can use less material while still efficiently dissipating the energy of a releasable clamp 102, which is particularly useful where space constraints are a concern.

Energy absorbing member 112 can comprise a variety of configurations. In one example, such as shown in FIGS. 3A-3C, the energy absorbing member 112 can comprise a honeycomb structure. The honeycomb structure of the energy absorbing member 112 can be designed to supply the necessary energy dissipation through selection of the size or surface area of the structure, the height of the structure, h, the size of the honeycomb cells, c, and the thickness of the honeycomb cell walls. In an example embodiment of the invention, the honeycomb energy absorbing member can have a height, h, of 0.50 inches, a cell size, c, of 0.125 inches. The thickness of the material of the cell structures can be 0.002 inches. The honeycomb structure of the energy absorbing member 112 can comprise a metallic makeup. In a specific example, the honeycomb structure of the energy absorbing member 112 can comprise aluminum.

Furthermore, the energy absorbing member 112 can comprise pre-crush initiators to facilitate optimum dissipation of energy through progressive localized buckling. For example, an energy absorbing member 112 having a honeycomb structure can comprise pre-crush initiators 118 at or about an impacting interface of the energy absorbing member. The pre-crush initiators 118 can function to reduce the high initial peak loads typically observed in the buckling of metallic members. This reduction of the initial peak loads allows for a more predictable and optimal progressive crush pattern, which can include a square wave energy dissipation method or a linear force over distance crush pattern.

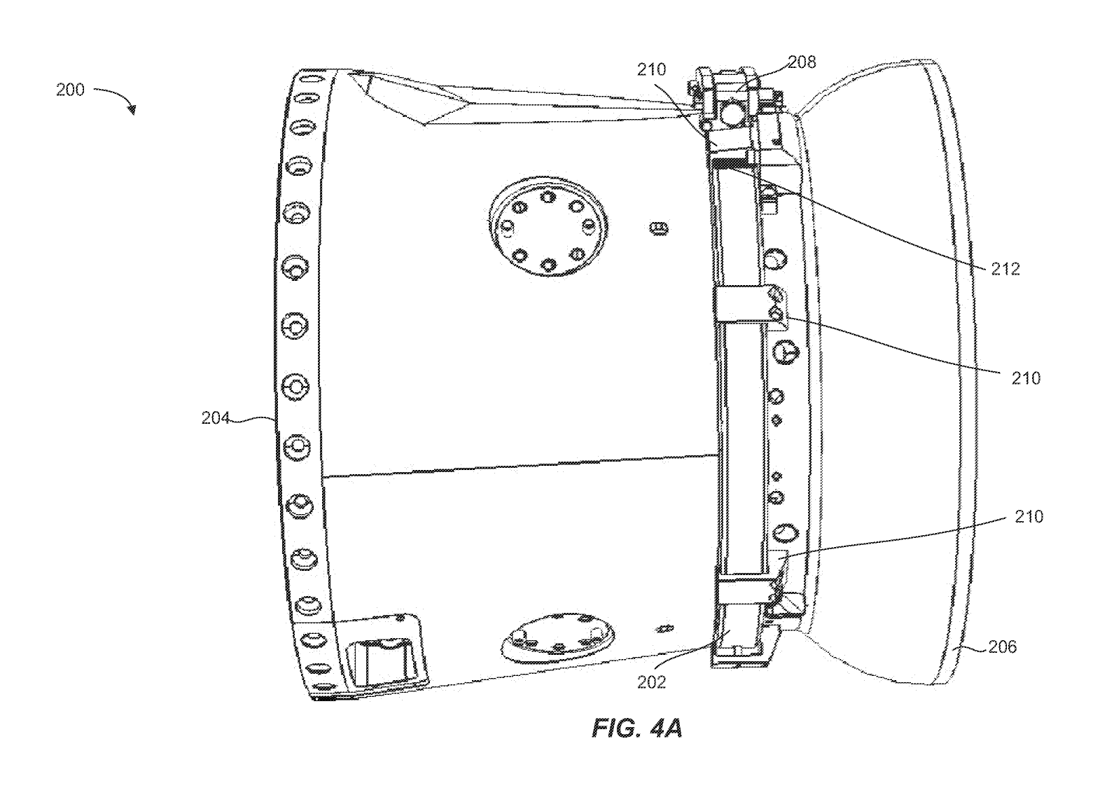

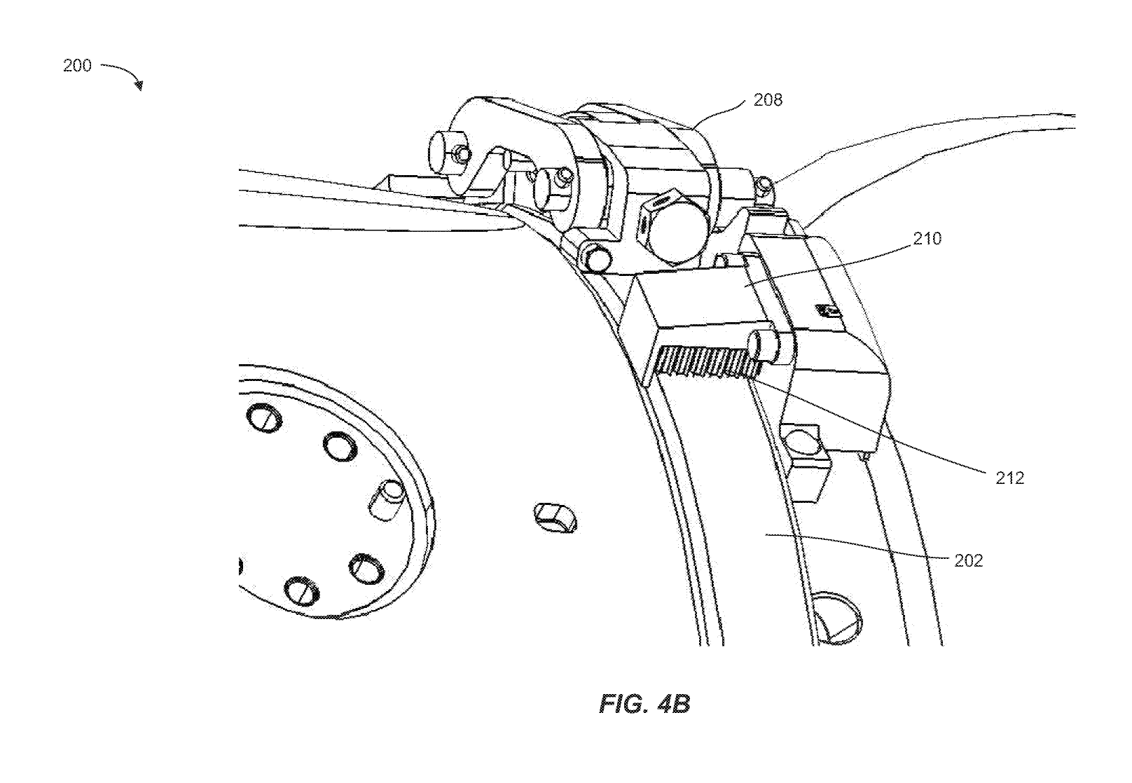

FIGS. 4A-4B show an example illustration of a clamp system 200 as applied to a missile assembly having separable bodies. Clamp system 200 can comprise a releasable clamp 202 operable to apply a clamping force about at least one of the first body 204 and the second body 206 of the missile assembly. First and second bodies 204, 206 are separable from one another and can be adjacent or abutted. In an example first body 204 can be an upper stage assembly of a missile and second body 206 can be a rocket motor. Releasable clamp 202 can comprise a securing mechanism 208 operable to facilitate clamping and release of the releasable clamp 202.

Upon release of securing mechanism 208, releasable clamp 202 can displace outward to facilitate separation of the first and second bodies 204, 206. Clamp system 200 can comprise one or more restraint devices 210 operable to limit the displacement of the releasable clamp 202 upon release of the securing mechanism 208. For example, restraint devices 210 can be located at intervals around the missile to contain the releasable clamp 202 in its released or open position. Restraint devices 210 can be secured to at least one of the first and second bodies 210, which will retain the releasable clamp 202 upon release and separation of the bodies.

One or more of the restraint devices 210 can further comprise an energy absorbing member 212 operable to interface with the releasable clamp 202 to dissipate an impact energy of the releasable clamp 202 upon release and displacement of the releasable clamp 202. The energy absorbing member 212 can be supported about at least one of the restraint devices 210, such as by an adhesive. The combination and positioning of restraint devices 210 and absorbing members 212 can be designed for optimum energy dissipation for any given application. In an example, one restraint device 210 comprises an energy absorbing member 212, while at least one additional restraint device 210 is operable to retain the releasable clamp 202 without an energy absorbing member due to possibly a level of impact energy at that additional restraint device 210 not of particular concern.

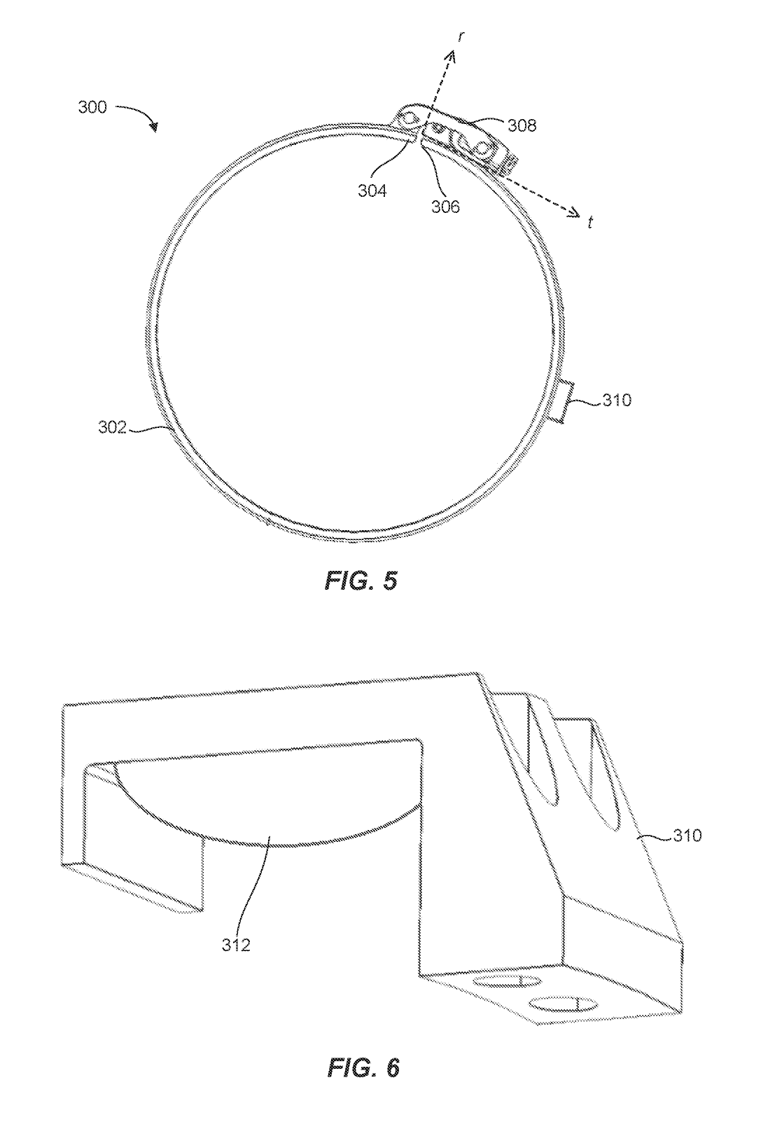

The location of the restraint device(s) 210 comprising an energy absorbing member 212 can be designed for optimum energy dissipation of the releasable clamp 202. For example, a restraint device 210 and associated energy absorbing member 212 can be located at a position where the release energy of the clamp is the greatest. In the example embodiment of the clamp system 200 shown, the energy absorbing member 212 is located substantially adjacent the securing mechanism 208. However, the location of the energy absorbing member can be varied to produce the desired energy dissipation, as further explained with reference to FIG. 5 below.

With reference to FIG, 5, another , example clamp system 300 is shown. Clamp system 300 can comprise a releasable clamp 302, with a first end 304 and a second end 306. First and second ends 304, 306 can be attached by a securing mechanism 308, which can be operable to facilitate clamping and release of the releasable clamp 302, Clamp system 300 can comprise one or more restraint devices 310 operable to limit the displacement of the releasable clamp 302 upon release. An energy absorbing member (not shown) can be supported about the restraint device 310 and operable to interface with the releasable clamp 302 to dissipate an impact energy of the releasable clamp 302. The location of the restraint device 310 having an energy absorbing member determines the effectiveness of the energy dissipation upon contact of the releasable clamp and the energy absorbing member. Different releasable clamps can displace in different manners. In some cases, this can be due to the variety in location and magnitude of the strain energy stored in the clamp in a closed or secured position. Thus, the configuration and location of the restraint device and associated energy absorbing member can be designed for the energy absorbing or dissipation requirements of each application.

In one aspect, the restraint device 310 and energy absorbing member can be located in a position nearly 90 degrees in either direction from the first and second ends 304, 306. As shown in FIG. 5, restraint device 310 can be located at or about 90 degrees in a clockwise direction from the first and second ends 304, 306. The location of a restraint device 310 in this position relative to the ends of the releasable clamp 302 will be most effective at absorbing energy if the displacement of the ends of the releasable clamp are primarily in a tangential direction (about the point of separation from one another) rather than a radial direction. For example, as securing mechanism 308 is released to allow the releasable clamp 302 to open and the first and second ends 304, 306 to displace, the first end 304 will displace due to the stored strain energy in the releasable clamp converting to kinetic energy. If the displacement of the first end 304 is primarily in the tangential direction, as indicated by arrow t, then the release energy about the clamp 302 will likely be the greatest about the restraint device 310 as located at or about 90 degrees in a clockwise direction from the first end 304.

Alternatively, if during the release of the releasable clamp 302, first end 304 has a displacement primarily in the radial direction, as indicated by arrow r, outward from the clamp, the release energy will likely be the greatest about a restraint device located adjacent the securing member 308. A restraint device 310 and associated energy absorbing member located adjacent the securing mechanism 308 can be effective at dissipating the release energy in this operational scenario (see, for example, securing mechanism 108 or 208 in FIGS. 2A-2D and FIGS. 4A-4B).

FIG. 6 illustrates yet another exemplary restraint device. Similar to the examples discussed above, the restraint device 310 can comprise an energy absorbing member 312. In this particular example, the energy absorbing member 312 can comprise any material suitable to absorb the release energy of a releasable clamp upon contact with the restraint device 310. For example, the energy absorbing member 312 can comprise a plastic, a metal, or a composite. The energy absorbing member 312 can take the form of a dome-shaped material suitable for contacting a releasable clamp and absorbing or dissipating the impact energy of the clamp, thereby decreasing the high-frequency shock levels that can be harmful to the clamped assemblies, such as missile assemblies and/or space flight vehicles.

A restraint device having an energy absorbing member can be suitable for a variety of applications beyond missile assemblies and space flight vehicles. Any assembly having a releasable clamp can utilize the inventive concepts discussed herein of absorption of the energy stored and converted during release of the clamp so as to protect the assembly or its contents. For example, sensitive connection points in vehicles and equipment having tubes or hoses such as exhaust lines, fuel lines, pneumatic lines, hydraulic lines, etc., or other connection points can benefit from the energy absorbing restraint devices discussed herein.

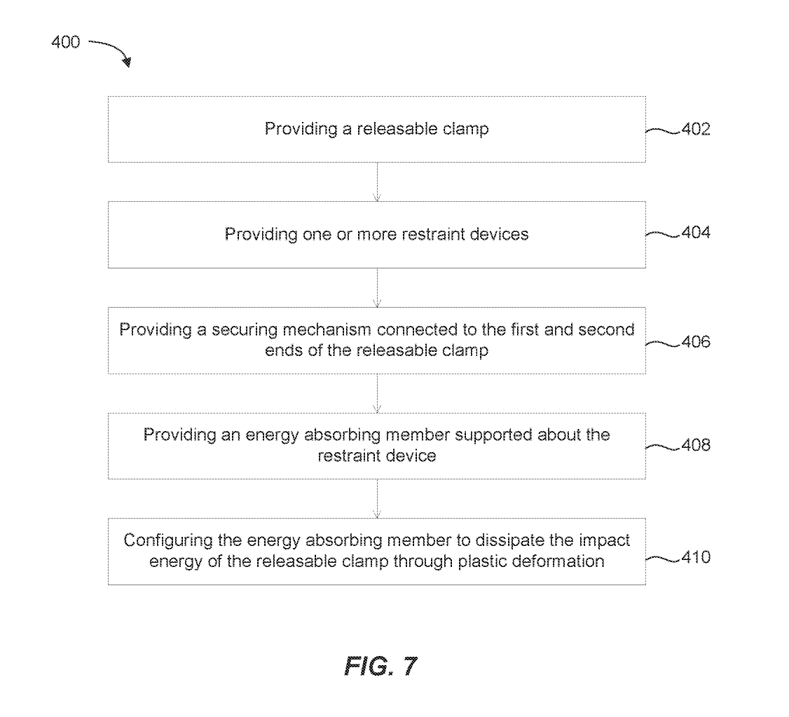

In accordance with one embodiment of the present invention, as shown in FIG. 7, a method for facilitating absorption of an impact energy of a releasable clamp 400 is disclosed. The method can comprise providing a releasable clamp 402. The releasable clamp can be a v-band or marman band clamp as discussed above. The method can comprise providing one or more restraint devices 404. The restraint devices, as discussed above, can be operable to limit the displacement of the releasable clamp upon release of the releasable clamp. The method can also comprise providing a securing mechanism connected to the first and second ends of the releasable clamp 406. The securing mechanism can be operable to facilitate clamping and release of the releasable clamp. The method can further comprise providing an energy absorbing member supported about the restraint device 408. The energy absorbing member can be operable to interface with the releasable clamp to dissipate an impact energy of the releasable clamp upon release of the securing mechanism and displacement of the releasable clamp. The method can additionally comprise configuring the energy absorbing member to dissipate the impact energy of the releasable clamp through plastic deformation.

The energy absorbing member of method 400 can comprise a honeycomb structure and can be of metallic makeup, such as aluminum. The releasable clamp of method 400 can be a v-band clamp or marman band. The method for facilitating absorption of an impact energy of a releasable clamp 400 can additionally include features as previously discussed with reference to FIGS. 1-6.

It is noted that no specific order is required in this method, though generally in one embodiment, these method steps can be carried out sequentially.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics can be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A clamp system comprising:
a releasable clamp having first and second ends disconnected from one another, the releasable clamp operable to apply a clamping force to secure one or more bodies;
one or more restraint devices operable to limit the displacement of the releasable clamp upon release of the releasable clamp;
a securing mechanism connected to the first and second ends of the releasable clamp, and operable to facilitate clamping and release of the releasable clamp; and
an energy absorbing member supported about the restraint device, and operable to interface with the releasable clamp to dissipate an impact energy of the releasable clamp upon release of the securing mechanism and displacement of the releasable clamp.

2. The clamp system of claim 1, wherein the energy absorbing member dissipates the impact energy of the releasable clamp through plastic deformation.

3. The clamp system of claim 1, wherein the energy absorbing member comprises a honeycomb structure.

4. The clamps system of claim 1, wherein the honeycomb structure comprises a metallic makeup.

5. The clamp system of claim 1, wherein the honeycomb structure comprises aluminum.

6. The clamp system of claim 1, wherein the energy absorbing member is located at a location where the release energy of the releasable clamp about the restraint device is the greatest.

7. The clamp system of claim 1, wherein the energy absorbing member is located at a location substantially adjacent the securing mechanism.

8. The clamp system of claim 1, wherein the energy absorbing member is supported about the restraint device by an adhesive.

9. The clamp system of claim 1, wherein the releasable clamp comprises a v-band clamp.

10. A clamp system comprising:
a first body;
a second body operable to interface with the first body, the first and second bodies being separable from one another;
a releasable clamp operable to apply a clamping force about at least one of the first and second bodies;
one or more restraint devices secured to at least one of the first and second bodies, and operable to retain the clamp about at least one of the first and second bodies; and
an energy absorbing member supported about at least one of the restraint devices and operable to interface with the clamp to dissipate an impact energy of the clamp upon release and displacement of the clamp.

11. The clamp system of claim 10, wherein the energy absorbing member dissipates the impact energy of the releasable clamp through plastic deformation.

12. The clamp system of claim 10, wherein the energy absorbing member comprises a honeycomb structure.

13. The clamps system of claim 12, wherein the honeycomb structure is aluminum.

14. The clamp system of claim 10, wherein the energy absorbing member is located at a location where the release energy of the releasable clamp about the restraint device is the greatest.

15. The clamp system of claim 10, wherein the energy absorbing member is located at a location substantially adjacent a securing mechanism.

16. The clamp system of claim 10, wherein the energy absorbing member is supported about the restraint device by an adhesive.

17. The clamp system of claim 10, wherein the releasable clamp is a v-band clamp.

18. A method for facilitating absorption of an impact energy of a releasable clamp, the method comprising:
providing a releasable clamp;
providing one or more restraint devices operable to limit the displacement of the releasable clamp upon release of the releasable clamp;
providing a securing mechanism connected to the first and second ends of the releasable clamp, and operable to facilitate clamping and release of the releasable clamp; and
providing an energy absorbing member supported about the restraint device, and operable to interface with the releasable clamp to dissipate an impact energy of the releasable clamp upon release of the securing mechanism and displacement of the releasable clamp.

19. The method of claim 18, further comprising configuring the energy absorbing member to dissipate the impact energy of the releasable clamp through plastic deformation.

20. The method of claim 18, wherein the energy absorbing member comprises a honeycomb structure.

21. The method of claim 18, wherein the releasable clamp is a v-band clamp.

22. A restraint device configured to absorb an impact energy of a clamp, the restraint device comprising:
a body having a receiving surface;
an energy absorbing member supported about the receiving surface, and operable to undergo plastic deformation in response to a load,
wherein the energy absorbing member comprises pre-crush initiators to facilitate optimum dissipation of energy through progressive localized buckling.

23. The restraint device of claim 21, wherein the energy absorbing member comprises a honeycomb structure.

24. The restraint device of claim 22, wherein the honeycomb structure is aluminum.
